(19) United States
(12) Patent Application Publication
(10) Pub. No.: US 2023/0187783 A1
(43) Pub. Date: Jun. 15, 2023

(54) ELECTRIC VEHICLE BATTERY AND BATTERY CELL INTERFACE MATERIAL THEREFOR

(71) Applicant: FEDERAL-MOGUL POWERTRAIN LLC, Southfield, MI (US)

(72) Inventors: Tianqi Gao, Malvern, PA (US); Scott McFarland, Phoenixville, PA (US); Alexis Zambino Mason, Phoenixville, PA (US); Jordan Boatwright, York, PA (US)

(21) Appl. No.: 18/077,629

(22) Filed: Dec. 8, 2022

Related U.S. Application Data
(60) Provisional application No. 63/287,879, filed on Dec. 9, 2021.

(51) Int. Cl. H01M 50/454; H01M 50/249; H01M 50/46; H01M 50/403

(52) U.S. Cl. CPC H01M 50/454; H01M 50/249; H01M 50/403; H01M 50/461; H01M 2220/20

(57) ABSTRACT

A battery cell interface material provides multiple types of protection between adjacent cells of an electric vehicle battery pack is provided. The interface material is an integral wall assembly having the following: a middle wall constructed of one of interlaced multifilament flame-resistant yarn or a non-woven material, the middle wall having opposite sides. A pair of intermediate layers, with each intermediate layer being bonded to a separate one of the opposite sides of the middle wall. A pair of outer layers, with each outer layer being bonded to a separate one of the pair of intermediate layers, such that each intermediate layer is sandwiched between one of the pair of outer layers and the textile middle wall, with each outer layer facing a cell wall of the electric vehicle battery being configured to be bonded directly to the cell wall.

### CROSS-REFERENCE TO RELATED APPLICATION

This application claims the benefit of U.S. Provisional Application Serial No. 63/287,879, filed Dec. 9, 2021, which is incorporated herein by reference in its entirety.

### BACKGROUND OF THE INVENTION

### 1. Technical Field

This invention relates generally to electric vehicle batteries, and more particularly to battery cell interface material therefor.

### 2. Related Art

It is known to separate individual battery cells of an electric vehicle battery from one another with an intervening wall of material. However, there remains a need to provide a single component, intervening wall assembly of different materials, thereby avoiding having to stack multiple separate walls of material together during assembly, while also being relatively thin, thereby avoiding the increase in the overall size of the electric vehicle battery. Further, there is a need to provide the intervening wall having an ability to maintain a constant stack-up pressure across the individual battery cells, thereby producing an optimized electrochemical reaction within each cell as it expands and contracts. Further yet, there is a need to provide the intervening wall having an ability to dissipate heat away from the cells and provide heat transfer within a plane of the intervening wall during operation of the battery, while also providing thermal and electrical insulation across the plane, while also providing dielectric, fire suppressant protection, thereby minimizing the potential for flame propagation between adjacent cells and thermal runaway to enable the vehicle to remain drivable under power from the battery system for at least 5 minutes after an initiation of a thermal runaway condition of one or more of the cells within the battery to enable a driver of the electric vehicle ample time to safely maneuver to a suitable parking location and vacate the vehicle.

### SUMMARY OF THE INVENTION

One object of the disclosure is to provide a single component, multilayer wall assembly that provides at least those desires discussed above for a battery cell interface material.

It is another object of the disclosure to provide a battery cell interface material having a laminated multilayer wall that is relatively thin, provides a substantially constant deflection force compression, is thermally conductive within a plane of the laminated multilayer wall, is thermally insulative across and transverse to the plane of the laminated multilayer wall dielectric, provides protection against thermal runaway and fire propagation, and possesses dielectric and electrical insulative properties.

It is another object of the disclosure to provide a battery cell interface material that facilitates enabling an electric vehicle battery system to supply power to the electric vehicle for 5 minutes or more.

In accordance these and other objects, a battery cell interface material provides multiple types of protection between adjacent cells of an electric vehicle battery pack is provided. The interface material is an integral wall assembly having the following: a middle wall constructed of one of interlaced multifilament flame-resistant yarn or a non-woven material, the middle wall having opposite sides. A pair of intermediate layers, with each intermediate layer being bonded to a separate one of the opposite sides of the middle wall. A pair of outer layers, with each outer layer being bonded to a separate one of the pair of intermediate layers, such that each intermediate layer is sandwiched between one of the pair of outer layers and the textile middle wall, with each outer layer facing a cell wall of the electric vehicle battery being configured to be bonded directly to the cell wall.

In accordance with another aspect of the invention, the middle wall has a thickness ranging between 0.5 mm to 10.0 mm.

In accordance with another aspect of the invention, the middle wall has a thickness ranging between 0.5 mm to 5.0 mm.

In accordance with another aspect of the invention, the middle wall has a thickness ranging between 0.5 mm to 3.0 mm.

In accordance with another aspect of the invention, the thickness of the middle wall is readily compressible to withstand and accommodate swelling and contraction and expansion of the adjacent battery cells during heating and cooling, and to impart a constant or substantially constant compressive and expansive force on the battery cells during the heating and cooling cycle, thereby allowing the cell medium within the battery cells to remain under a desired uniform, substantially constant force, thereby minimizing stress on the cell medium and optimizing the useful life of the battery pack.

In accordance with another aspect of the invention, the middle wall is configured to trap air therein to enhance the thermal insulation and inhibit thermal transfer from a battery cell on one side of the middle wall to another battery cell on an opposite side of the middle wall.

In accordance with another aspect of the invention, the middle wall can be woven.

In accordance with another aspect of the invention, the woven wall can include multiple layers in overlying relation with one another

In accordance with another aspect of the invention, the woven wall can include multiple layers interlaced together yarn(s) from one layer being interlaced with yarn(s) of the other layer.

In accordance with another aspect of the invention, the middle wall can be knitted.

In accordance with another aspect of the invention, the knitted wall can include multiple layers interlaced together with knit stitches transferring from one layer to the opposite layer.

In accordance with another aspect of the invention, the middle wall can be a non-woven layer, with the non-woven layer having flame-resistant fibers, such as mineral fibers, such as fiberglass, ceramic, silica, and basalt fibers, interlocked with one another via any suitable non-woven fabrication process.

In accordance with another aspect of the invention, the flame-resistant yarn of the middle wall is a mineral yarn.

In accordance with another aspect of the invention, the mineral yarn can be provided as at least one of fiberglass, ceramic, silica, and basalt yarn.

In accordance with another aspect of the invention, the intermediate layers can be constructed from a silica-based or mica-based material.

In accordance with another aspect of the invention, the intermediate layers have a thickness less than 1.0 mm.

In accordance with another aspect of the invention, at least one of the opposite sides of the intermediate layers can have a pressure sensitive adhesive bonded thereto, with the pressure sensitive adhesive being directly bonded to the middle wall.

In accordance with another aspect of the invention, the pressure sensitive adhesive bonded to the intermediate layers can be an acrylic or silicone-based material.

In accordance with another aspect of the invention, an outer periphery of the intermediate layers can be sized to extend beyond an outer periphery of the middle wall, such that the pressure sensitive adhesive layer adjacent the outer periphery of one intermediate layer can be bonded to the pressure sensitive adhesive layer adjacent the outer periphery of the other intermediate layer, thereby encapsulating the middle wall between the intermediate layers via the outer peripheries of the intermediate layers being bonded directly to one another.

In accordance with another aspect of the invention, the outer layers can be constructed including thermally conductive filler material to facilitate the transfer of heat away from an adjacent battery cell within a plane of the outer layers to a heat sink member, such as a cooling plate of the battery.

In accordance with another aspect of the invention, the outer layers have a thickness less than 1.0 mm.

In accordance with another aspect of the invention, the outer layers can have an outer periphery being the same size and shape as the outer peripheries of the intermediate walls to facilitate encapsulating the middle wall in sealed relation between the intermediate and outer layers.

In accordance with another aspect of the invention, a battery cell interface material for an electric vehicle battery comprises: an integral wall assembly including: a middle wall constructed of one of interlaced multifilament flame-resistant yarn or a non-woven material, with the middle wall having opposite sides. A pair of intermediate layers, with each intermediate layer having a thickness less than 1.0 mm and being bonded directly to a separate one of the opposite sides of the textile middle wall. A pair of outer layers, with each outer layer having a self-adhesive bonded to a separate one of the pair of intermediate layers, such that each intermediate layer is sandwiched between one of the pair of outer layers and the middle wall, with each outer layer that faces a cell wall of the electric vehicle battery having a self-adhesive configured to be bonded directly to the cell wall.

In accordance with another aspect of the invention, a battery pack for an electric vehicle includes: a plurality of cells, with adjacent cells having cell walls facing one another. An integral wall assembly including: a middle wall constructed of one of woven or knitted multifilament flame-resistant yarn or a non-woven material, with the middle wall having opposite sides; a pair of intermediate layers, with each intermediate layer being bonded to a separate one of the opposite sides of the middle wall; a pair of outer layers, with each outer layer being bonded to a separate one of the pair of intermediate layers, such that each intermediate layer is sandwiched between one of the pair of outer layers and the middle wall, with each outer layer facing one of the cell walls being bonded to the cell wall.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a perspective view of a motor vehicle having an electric vehicle battery including a battery cell interface material constructed in accordance with one aspect of the disclosure;

FIG. 1A is a schematic fragmentary plan view of the electric vehicle battery of FIG. 1 illustrating the battery cell interface material sandwiched between adjacent battery cells of the electric vehicle battery to thermally insulate and isolate the adjacent battery cells from one another;

FIG. 2 is an exploded perspective view of a battery cell interface material of the electric vehicle battery of FIG. 1 in accordance with an aspect of the disclosure;

FIG. 2A is a fragmentary cross-sectional view of the battery cell interface material of FIG. 2;

FIG. 2B is a fragmentary cross-sectional view of a battery cell interface material constructed in accordance with another aspect of the disclosure;

FIG. 2C is a fragmentary cross-sectional view of a battery cell interface material constructed in accordance with yet another aspect of the disclosure; and

FIG. 3 is a fragmentary cross-section view taken through an outer periphery of any one of the battery cell interface materials of FIGS. 2A-2C.

### DETAILED DESCRIPTION OF PREFERRED EMBODIMENTS

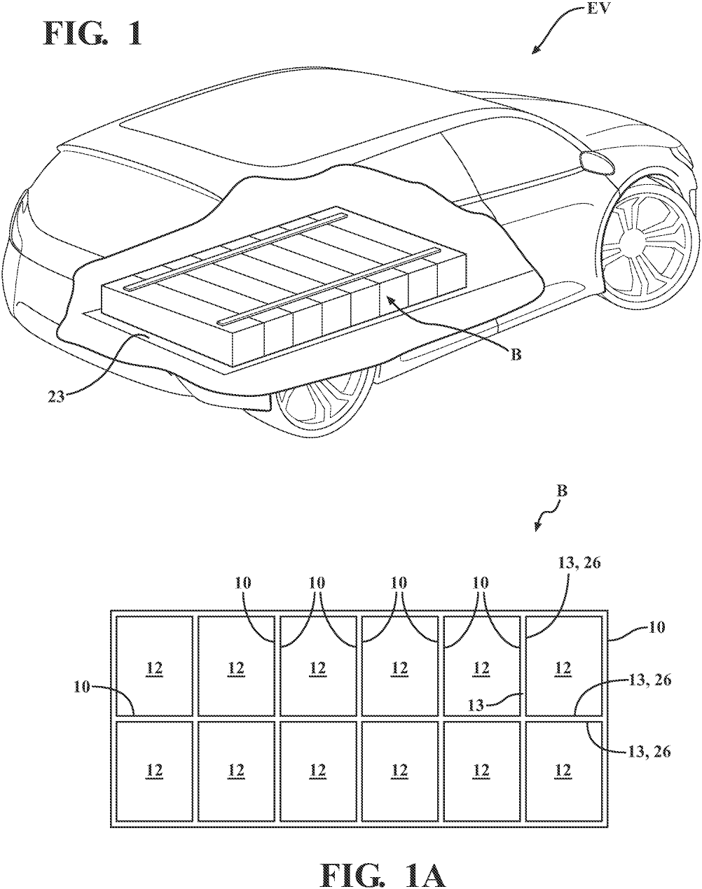

Referring in more detail to the drawings, FIG. 1 illustrates an electric vehicle EV having an electric vehicle battery pack, referred to hereafter as battery B, having one or more unitized pieces of battery cell interface material, referred to hereafter as interface material 10 (shown schematically in FIG. 1A), wherein the interface material 10 provides multiple types of protection to a plurality of cells 12, and between adjacent cells 12 of the electric vehicle battery B. The interface material 10 is provided as an integral wall assembly 11 (integral meaning the wall assembly can be handled as a single piece of material, with individual pieces of material of the assembly being operably fixed to one another to prevent separation of the individual layers from one another). The wall assembly 11 includes a middle wall 14 formed at least in part, or in its entirety, by interlaced multifilament flame-resistant yarn 15. The wall assembly 11 further includes a pair of intermediate layers 16, with a separate one of the intermediate layers 16 being bonded to opposite sides 18, 19 of the middle wall 14. The intermediate layers 16 are flame resistant, and thus, function to inhibit thermal transfer between the battery cells 12 located adjacent opposite sides 20, 21 of the integral wall assembly 11. The wall assembly 11 further includes a pair of outermost layers, referred to hereafter as outer layers 22, with each outer layer 22 being bonded directly to an outwardly facing side 24 of the intermediate layers 16, such that each one of the intermediate layers 16 is sandwiched between one of the outer layers 22 and the middle wall 14. The outer layers 22 are provided as a double-sided pressure sensitive adhesive tape, with one side S1 of the pressure sensitive adhesive tape 22 being bonded directly to a respective one of the intermediate layers 14 and the other side S2 of the pressure sensitive adhesive 22 being bonded directly to an outer surface 26 of a battery cell wall 13. Adjacent cells 12 have cell walls 13 facing one another, with the outer layers 22 of the integral wall assembly 11 being bonded directly to each cell wall 13.

The interface material 10 protects the cells 12 against impact forces, such as may be experienced in a vehicle crash, and against the ingress of contamination, by way of example and without limitation, and further provides a constant or substantially constant (meaning nearly constant) compression force deflection during thermal expansion and contraction of the cells 12. Accordingly, as the interface material 10 is compressed between expanding, heated adjacent cells 12, the interface material 10 imparts a constant or substantially constant force under compression, and thereafter can elastically expand during cooling contraction of the cells 12, thereby allowing the cells 12 to expand and contract without undue stress in use, and allowing the interface material 10 to maintain contact with the adjacent cell walls 13 to optimize conduction and heat dissipating outwardly from the cells 12. The interface material 10 further provides thermally conductive properties within and along a plane P of the outer layers 22 of the wall assembly 11, such that heat can be transferred away from the cells 12 along the outer layers 22 to a heat sink member 23, such a cooling plate that can be located as desired, such as at a base of the battery B, by way of example and without limitation. With the outer layers 22 being bonded directly to the outer surface 26 of the battery cell wall 13, thermal conduction is optimized by providing a direct path for conduction of heat within the cells 12 to be dissipated outwardly from the cells 12 along the plane P to the outside environment, and to the heat sink member 23, if provided. The interface material 10 further yet provides thermally insulative properties in a direction extending transverse to and across the plane P, while further providing electrical insulation and additional properties to thermally suppress flame propagation, such as in the event of thermal runaway of one or more of the cells 12 of the battery B, thereby allowing the electric vehicle EV to remain powered by the battery for 5 minutes or more to allow the electric vehicle EV to be safely driven to a parking location, whereat the operator can evacuate the electric vehicle EV.

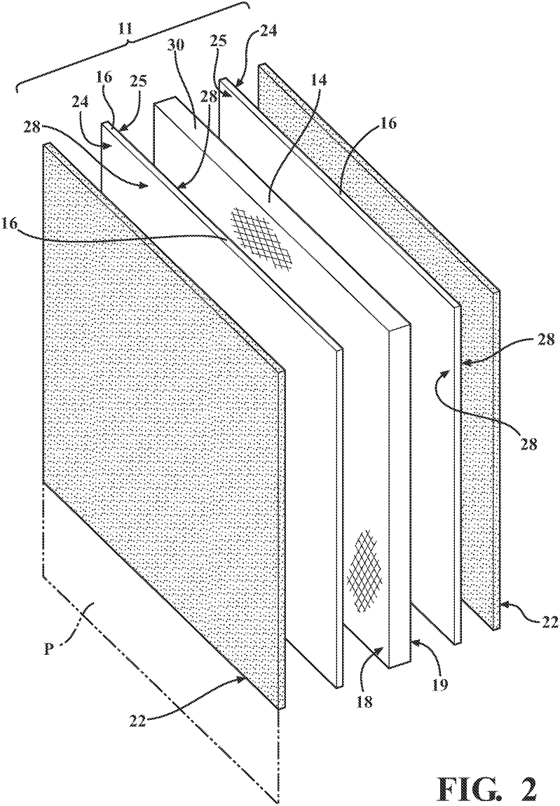

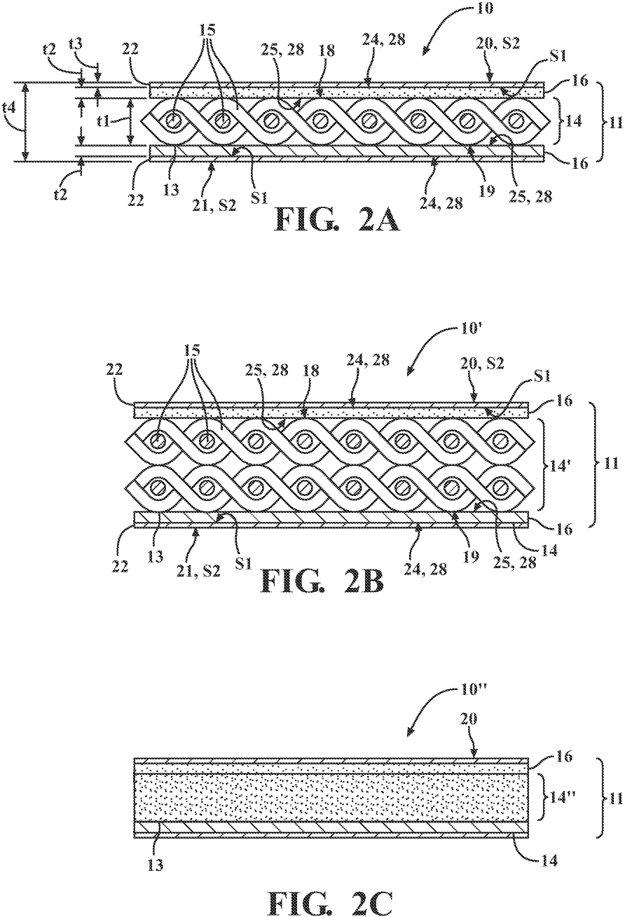

In accordance with another aspect of the invention, the middle wall 14 is constructed having a desired thickness (t1) ranging between 0.5 mm to 10.0 mm, and preferably between 0.5 mm to 5 mm, depending on the specifics of the application, thereby lending to the relative thinness of the wall assembly 11. By controlling the thickness t1 of the wall assembly 11, and minimizing the overall thickness t1, the allotted space within the battery pack B for cells 12 is increased, thereby allowing a maximum number of cells 12 to be provided, thereby increasing the energy density of the battery pack B without compromising battery life and without having to increase the overall size and weight of the battery pack B. The middle wall 14 is compressible in a direction across its thickness to withstand swelling and contraction of the adjacent battery cells 12, as discussed above. The middle wall 14 is configured to trap air therein, due to its textile construction, to enhance the thermal insulation and inhibit thermal transfer from a battery cell 12 on one side of the middle wall 14 to another battery cell 12 on an opposite side of the middle wall 14. The middle wall 14 can be woven as a single layer of material (FIG. 2A) using any desired weave pattern, such as a plain weave pattern, by way of example and without limitation, or the middle wall 14′ can be provided as multiple woven layers in overlying abutment with one another, shown as a pair of layers (FIG. 2B). The multiple layers of the middle wall 14′ can be interlaced together in a single weaving process with weft and/or warp yarns of the abutting layers 14a, 14b being woven in interwoven relation with one another, if desired. The multiple layers provide an ability to trap air therein, thus, increasing the thermal insulation property of the middle wall 14′.

In accordance with another aspect of the invention, the middle wall 14 can be knitted using any desired knit type stitches. The knitted wall 14 can include a single layer (such as shown in FIG. 2A) or multiple layers (such as shown in FIG. 2B) interlaced together in a single knitting process with knit stitches extending between abutting knit layers.

In accordance with another aspect of the invention, the flame-resistant yarn of the middle wall 14 can be provided as mineral yarn. The mineral yarn can be provided as at least one of fiberglass, ceramic, silica, and basalt yarn. The middle wall 14, 14′ can be precisely tailored to provide a desired compression force between adjacent cells 12 through careful selection of the type and size of the mineral yarn, the type of interlacing (weave or knit), and the respective weave or knit pattern used for the interlacing, thereby allowing the interface material 10, 10′ to be customized in manufacture to withstand and accommodate swelling properties of cells having different cell chemistries.

In accordance with another aspect of the invention, as shown in FIG. 2C, the middle wall 14″ can be provided as a non-woven layer, with the non-woven layer 14″ being formed of flame-resistant fibers, such as mineral fibers, such as including at least one of fiberglass, ceramic, silica, and basalt fibers, interlocked with one another via any suitable non-woven fabrication process.

In accordance with another aspect of the invention, the intermediate layers 16 can be constructed from a mica-based material. The intermediate layers 16 have a thickness (t2) less than 1.0 mm, thereby lending to the relatively thin thickness of the wall assembly 11. Opposite sides 24, 25 of the intermediate layers 16 can have a pressure sensitive adhesive 28 bonded thereto, with the pressure sensitive adhesive 28 on one side 25 being bonded to the middle wall 14. The pressure sensitive adhesive 28 bonded to the intermediate layers 16 can be an acrylic or silicone-based material, thereby being heat resistant.

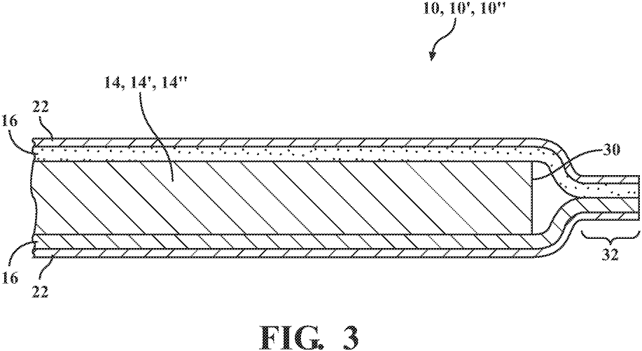

In accordance with another aspect of the invention, as shown in FIG. 3, outer peripheries of the intermediate layers 16 can be sized to extend beyond an outer periphery 30 of the middle wall 14, such that the pressure sensitive adhesive layer 28 of one intermediate layer 16 can be bonded to the pressure sensitive adhesive layer 28 of the other intermediate layer 16, thereby forming a bonded, sealed outer periphery section 32 encapsulating the middle wall 14 between the intermediate layers 16.

In accordance with another aspect of the invention, the outer layers 22 can be constructed including thermally conductive filler material to facilitate the transfer of heat away from an adjacent battery cell 12 within and along the plane P of the outer layers 22 to the aforementioned heat sink member 23, such as a cooling plate of the battery B. The outer layers 22 have a thickness (t3) less than 1.0 mm, thereby further lending to the relative thinness of the thickness (t4) wall assembly 11. The outer layers 22 can be sized having the same outer peripheral shape and size as the intermediate walls 16, in matching mirrored relation therewith, to facilitate bonding the outer peripheries of the intermediate layers 16 and the outer layers 22 together, thereby encapsulating the middle wall 14 in sealed relation between the intermediate 16 and outer layers 22.

In accordance with another aspect of the invention, an electric vehicle battery B having a plurality battery cells 12 isolated from one another by a battery cell interface material 10 as described above is provided. The isolation provided by the interface material 10 provides a constant compression force of deflection between the adjacent cells 12, as discussed above; provides a path for thermal conduction along a plane P defined between the adjacent cells 12 to a heat sink 23; provides thermal insulation in a direction extending oblique or transverse to the plane P defined between the adjacent cells 12; provides thermal runaway protection (flame propagation) between the adjacent cells 12, thereby inhibiting one cell 12 from causing another cell 12 from being thermally affected or to erupt in flame; and provides electrical insulation between the adjacent cells 12.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

1. A battery cell interface material for an electric vehicle battery, comprising:
an integral wall assembly comprising:
a middle wall constructed of one of interlaced multifilament flame-resistant yarn or a non-woven material, said middle wall having opposite sides;
a pair of intermediate layers, with each intermediate layer being bonded to a separate one of said opposite sides of said middle wall;
a pair of outer layers, with each outer layer being bonded to a separate one of said pair of intermediate layers, such that each intermediate layer is sandwiched between one of said pair of outer layers and said textile middle wall, with each outer layer facing a cell wall of the electric vehicle battery being configured to be bonded directly to the cell wall.

2. The battery cell interface material of claim 1, wherein said pair of outer layers are provided as a double-sided pressure sensitive adhesive, with one side of each pressure sensitive adhesive being bonded to one of said pair of intermediate layers and the other side of each pressure sensitive adhesive being configured to be bonded to an outer surface of a battery cell wall.

3. The battery cell interface material of claim 2, wherein said middle wall has a thickness between 0.5 mm to 5 mm.

4. The battery cell interface material of claim 2, wherein said middle wall is one of a woven layer, knitted layer or a non-woven layer.

5. The battery cell interface material of claim 2, wherein said middle wall includes a pair of woven layers or knitted layers overlying one another.

6. The battery cell interface material of claim 2, wherein said middle wall is woven or a knitted from mineral yarns.

7. The battery cell interface material of claim 2, wherein said middle wall is a non-woven layer formed including at least one of fiberglass fibers, ceramic fibers, silica fibers, and basalt fibers.

8. The battery cell interface material of claim 2, wherein said pair of intermediate layers have an outer periphery that extend beyond an outer periphery of said middle wall, said outer peripheries of said intermediate layers being bonded to one another to encapsulate said outer periphery of said middle wall.

9. The battery cell interface material of claim 2, wherein said pair of intermediate layers are constructed from a mica-based material.

10. The battery cell interface material of claim 9, wherein said pair of intermediate layers each have a thickness less than 1.0 mm.

11. The battery cell interface material of claim 9, wherein said intermediate layers have a pressure sensitive adhesive bonded thereto, with the pressure sensitive adhesive being bonded to said middle wall.

12. A battery cell interface material for an electric vehicle battery, comprising:
an integral wall assembly including:
a middle wall constructed of one of interlaced multifilament flame-resistant yarn or a non-woven material, said middle wall having opposite sides;
a pair of intermediate layers, with each intermediate layer having a thickness less than 1.0 mm and being bonded directly to a separate one of said opposite sides of said textile middle wall; and
a pair of outer layers, with each outer layer having a self-adhesive bonded to a separate one of said pair of intermediate layers, such that each intermediate layer is sandwiched between one of said pair of outer layers and said middle wall, with each outer layer facing a cell wall of the electric vehicle battery having a self-adhesive bonded directly to the cell wall.

13. A battery pack for an electric vehicle, comprising:
a plurality of cells, with adjacent cells having cell walls facing one another;
an integral wall assembly comprising:
a middle wall constructed of one of woven or knitted multifilament flame-resistant yarn or a non-woven material, said middle wall having opposite sides;
a pair of intermediate layers, with each intermediate layer being bonded to a separate one of said opposite sides of said middle wall;
a pair of outer layers, with each outer layer being bonded to a separate one of said pair of intermediate layers, such that each intermediate layer is sandwiched between one of said pair of outer layers and said middle wall, with each outer layer facing one of said cell walls being bonded to said cell wall.

14. The battery pack of claim 13, wherein said middle wall includes a pair of woven layers or knitted layers overlying one another.

15. The battery pack of claim 13, wherein said flame-resistant yarn is mineral yarn.

16. The battery pack of claim 15, wherein said mineral yarn include at least one of fiberglass yarn, ceramic yarn, silica yarn, and basalt yarn.

17. The battery pack of claim 13, wherein said textile middle wall is a non-woven material formed including at least one of fiberglass fibers, ceramic fibers, silica fibers, and basalt fibers.

18. The battery pack of claim 13, wherein said pair of intermediate layers have an outer periphery that extend beyond an outer periphery of said middle wall, said outer peripheries of said intermediate layers being bonded to one another to encapsulate said outer periphery of said middle wall.

19. The battery pack of claim 13, wherein said pair of intermediate layers are constructed from a mica-based material.

20. The battery pack of claim 19, wherein said intermediate layers have a pressure sensitive adhesive bonded thereto, with the pressure sensitive adhesive being bonded to said middle wall.
